(19) United States
(12) Patent Application Publication
(10) Pub. No.: US 2013/0062449 A1
(43) Pub. Date: Mar. 14, 2013

(54) LIFTER BAR ASSEMBLY AND GRINDING MILL INCLUDING SAME

(71) Applicants: Pramod Kumar, Waterloo (CA); Raj K. Rajamani, Salt Lake City, UT (US); David J. Page, Elora (CA); Robert Mepham, Fergus (CA)

(72) Inventors: Pramod Kumar, Waterloo (CA); Raj K. Rajamani, Salt Lake City, UT (US); David J. Page, Elora (CA); Robert Mepham, Fergus (CA)

(73) Assignee: POLYCORP LTD., Elora, ON (CA)

(21) Appl. No.: 13/697,570

(22) PCT Filed: May 13, 2011
(86) PCT No.: PCT/CA2011/000554

§ 371 Date: Nov. 13, 2012

Related U.S. Application Data
(60) Provisional application No. 61/334,810, filed on May 14, 2010.

(51) Int. Cl. B02C 17/18

(52) U.S. Cl. 241/284

(57) ABSTRACT

A grinding mill including one or more lifter bar assemblies mounted on a shell rotatable around a central axis thereof. Each lifter bar assembly is for lifting at least a lifted portion of a charge including ore, and includes a main portion for lifting and directing a main part of the lifted portion in a main part direction substantially orthogonal to the central axis of the shell. The lifter bar assembly also includes one or more terminal lifter bars located proximal to one or both of feed and discharge ends of the shell, for lifting and directing terminal part(s) of the lifted portion of the charge. The terminal lifter bar is positioned for directing the terminal part of the lifted portion of the charge at least partially in a terminal part direction which is substantially non-aligned with the main part direction.

### TECHNICAL FIELD

The present invention is related to a grinding mill including lifter bar assemblies mounted on a shell of the grinding mill.

### BACKGROUND OF THE INVENTION

In known autogenous and semi-autogenous grinding mills, ore-bearing material is comminuted by the impact of other ore due to a cataracting or tumbling motion resulting from the rotation of the shell about its central axis. (In a semi-autogenous grinding mill, the ore is also comminuted by grinding media, as well as by the ore itself.) A charge, including ore (and, in a semi-autogenous mill, also including grinding media) is positioned in the shell. As is well known in the art, lifter bars are positioned on the shell for lifting a portion of the charge as the shell is rotated, to provide a better cataracting motion, i.e., to lift the portion of the charge higher than the charge would have been raised, in the absence of the lifter bars.

A longitudinal cross-section of a typical prior art mill 10 is illustrated in FIG. 1. The grinding mill 10 includes a shell 11 rotatable about a central axis 27 thereof. The ore (not shown in FIG. 1) is fed into the mill at a feed end 12 of the shell 11, and the mill is designed so that the ore is moved to a discharge end 14 as the shell 11 rotates, with the comminuted ore (i.e., those pieces of ore which are less than a desired maximum size) ultimately exiting the mill via the discharge end 14 thereof. The overall direction of the movement of the ore in the shell is generally indicated by arrow T in FIG. 1. As is well known in the art, the flow of the comminuted ore out of the shell at the discharge end is controlled by discharge grate plates, the location of which is generally indicated at 15 in FIG. 1.

In a typical mounting arrangement, a number of the lifter bars 16 are mounted end-to-end on the shell 11 to define a number of substantially straight assemblies 18 (FIG. 2A) of lifter bars 16 extending substantially parallel to the central axis of the shell between the feed and the discharge ends 12, 14 of the shell 11. It will be understood that only a few of the prior art lifter bar assemblies 18 are shown in FIG. 1, for clarity of illustration. As is well known in the art, the lifter bar assemblies typically are mounted around the circumference of the inner diameter of the shell.

Typical prior art lifter bar assemblies 18 are shown in FIGS. 2A and 2B. The conventional lifter bar assemblies 18 typically are spaced apart laterally by predetermined distances. Such lateral spacing is determined according to a number of factors, as is well known in the art. For example, one such predetermined distance is designated “S” in FIG. 2A, for clarity of illustration.

As can be seen in FIGS. 2A and 2B, the typical lifter bar assembly 18 includes one or more lifter bars 16 defining an elongate main portion 20 of the lifter bar assembly 18, and end lifter bars 22 positioned at opposite ends 24, 26 of the main portion 20. For purposes of illustration, the end lifter bars 22 positioned at the ends 24, 26 are identified in FIG. 2A as 22A and 22B respectively. For instance, as illustrated in FIG. 2A, the end 22A is positioned proximal to the feed end 12, and the end 22B is positioned proximal to the discharge end 14. As is well known in the art, the lifter bars 16, 22 are attached to the shell 11 by any suitable means (not shown in FIGS. 1, 2A, and 2B), e.g., fasteners such as bolts 17 (inserted through holes in the shell 11) and nuts 19, as illustrated in FIG. 2C. Such means for fastening are included in the lifter bar assemblies 18. Plates P (FIG. 2C) are also mounted on the shell, between the lifter bar assemblies, as is known in the art. It will be understood that, for clarity of illustration, the plates are omitted from the drawings except FIG. 2C. (As will be described, the balance of the drawings illustrate the invention herein.)

The direction of rotation of the shell in FIGS. 2A and 2B is indicated by arrow A. In FIGS. 2A and 2B, such direction is understood to be in the counter-clockwise direction, i.e., if the rotating shell is viewed from the discharge end, i.e., from the right side of FIGS. 1 and 2A as presented. (As illustrated in FIG. 1, the discharge end 14 is shown at the right-hand side of the drawing.) As is well known in the art, the grinding mill may be built so that shell may be rotated in either direction, i.e., clockwise, or counter-clockwise. It will be understood that, in FIG. 2B, the direction of movement of the lifted portion of the charge is schematically represented by arrows B₁-B₆. For clarity of illustration, the charge is omitted from FIG. 2B. In FIG. 2B, the lifter bar assemblies 18 are substantially parallel to the central axis 27 (not shown in FIG. 2B). As indicated in FIG. 2B, the lifted portion of the charge is directed in a direction generally orthogonal to the central axis 27 of the shell. Also, movement of the ore into the shell at the feed end 12 is schematically represented by arrow C, and movement of the ore after comminution thereof out of the shell at the discharge end 14 is schematically represented by arrow D (FIGS. 1, 2B).

As is well known in the art, the movement of the charge inside the shell causes severe wear on the elements of the mill inside the shell, in particular, those elements located at the feed end and the discharge end, especially the discharge grates. For instance, some of the ore which has not yet been ground to the size necessary to enable it to pass through the grates is brought into contact with the discharge grates due to the shell's rotation, causing severe wear on the grate plates. As a result, the grate plates are required to be replaced relatively frequently. Such replacement is very costly. In addition to the cost of purchasing and installing replacement grate plates, the production time (i.e., foregone mill throughput) lost due to the shutdown for replacement represents a significant cost. Similar costs are incurred in connection with replacement of other elements at the feed and discharge ends. Also, the wear results from rotation of the shell, which requires energy inputs. To the extent that the energy expended results in wear, rather than comminution, the energy is not productively used.

The rate of movement of the ore through the shell is sometimes required to be changed, to improve performance. In the prior art, the throughput rate may be affected by changes in a wide variety of parameters. Changes in parameters beyond an operator's control (e.g., energy costs) can cause what had been optimum performance to become less than optimum. For example, a significant change in one or more of the relevant characteristics of the ore may result in a decrease in throughput. In practice, however, the extent to which any such parameters are changeable by the operator varies.

### SUMMARY OF THE INVENTION

For the foregoing reasons, there is a need for a lifter bar assembly that addresses or mitigates one or more of the disadvantages of the prior art. In particular, there is a need for lifter bar assemblies that are positioned to at least partially control movement of the charge in the shell, in a predetermined manner. For instance, in one embodiment, the lifter bar assembly of the invention is useable to reduce wear on elements of the mill at the feed end and/or the discharge end of the shell, thereby resulting in less frequent replacement of discharge grate plates and other elements at the feed and discharge ends, and reducing costs significantly.

In its broad aspect, the invention provides a grinding mill including a shell rotatable around a central axis thereof, an interior side of the shell at least partially defining a cavity therein, and the shell extending between a feed end thereof, at which ore is introduced into the cavity, and a discharge end, at which the ore exits the cavity, after comminution thereof. The grinding mill also includes one or more lifter bar assemblies mounted on the shell for lifting at least a lifted portion of a charge including the ore in the cavity as the shell rotates for comminution of the ore. Each lifter bar assembly includes a main portion for lifting and directing a main part of the lifted portion of the charge, the main portion having at least one main portion lifter bar at least partially defined by a center axis thereof. The main portion lifter bar being mounted to the interior side of the shell to locate the center axis thereof substantially parallel to the central axis of the shell. The main portion extends between two respective ends thereof and is positioned for directing the main part of the lifted portion of the charge in a main part direction substantially orthogonal to the central axis of the shell. The lifter bar assembly also includes one or more terminal lifter bars, each being for lifting and directing one or more terminal parts of the lifted portion of the charge. Each terminal lifter bar extends between inner and outer ends thereof and is mounted to the interior side of the shell. The outer end of each terminal lifter bar is positioned proximal to a selected end of the shell selected from the group consisting of the feed and discharge ends thereof. Each terminal lifter bar is positioned for directing the terminal part of the lifted portion of the charge positioned thereon at least partially in a terminal part direction which is substantially non-aligned with the main part direction.

In another embodiment, the grinding mill includes lifter bar assemblies, each including a pair of terminal lifter bars for lifting and directing a terminal part of the lifted portion of the charge. The terminal lifter bars include a feed end terminal lifter bar and a discharge end terminal lifter bar, each terminal lifter bar extending between inner and outer ends thereof and mounted to the interior side of the shell. The outer end of the feed end terminal lifter bar is located proximal to the feed end of the shell, and the outer end of the discharge end terminal lifter bar is located proximal to the discharge end of the shell. The main portion extends between feed and discharge ends thereof, the feed end of the main portion being positioned at a predetermined distance from the feed end of the shell, and the discharge end of the main portion being positioned at a predetermined distance from the discharge end of the shell. The feed end and discharge end terminal lifter bars are positioned for directing the feed and discharge terminal parts of the lifted portion of the charge respectively at least partially in feed and discharge terminal part directions which are substantially non-aligned with the main part direction.

In another aspect, the invention provides a lifter bar assembly for lifting a portion of a charge including ore in a shell of a grinding mill for comminution of the ore, the shell being rotatable around a central axis thereof and extending between feed and discharge ends thereof, the shell having an interior side thereof at least partially defining a cavity therein. The lifter bar assembly is mountable on the shell, and includes a main portion for lifting and directing a main part of the lifted portion of the charge, the main portion including one or more main portion lifter bars at least partially defined by a center axis thereof. The main portion lifter bar is mountable on the interior side of the shell to locate the center axis thereof substantially parallel to the central axis of the shell. The main portion is positionable for directing the main part in a main part direction substantially orthogonal to the central axis of the shell. The lifter bar assembly also includes one or more terminal lifter bars for lifting and directing one or more terminal parts of the lifted portion of the charge. Each terminal lifter bar extends between inner and outer ends thereof and is mountable to the interior side of the shell, to locate the outer end thereof proximal to a selected end of the shell selected from the group consisting of the feed and discharge ends thereof. Each terminal lifter bar is positionable on the interior side for directing the terminal part of the lifted portion of the charge engaged with the terminal lifter bar at least partially in a terminal part direction which is substantially non-aligned with the main part direction.

### BRIEF DESCRIPTION OF THE DRAWINGS

The invention will be better understood with reference to the attached drawings, in which:

FIG. 1 (previously described) is a longitudinal cross-section of a typical grinding mill of the prior art showing a plurality of lines of lifter bars mounted on the shell;

FIG. 2A (previously described) is a top view of a typical lifter bar assembly of the prior art mounted in the prior art grinding mill of FIG. 1, drawn at a larger scale;

FIG. 2B (previously described) is a partial isometric view of the prior art lifter bar assembly of FIGS. 1 and 2A, drawn at a smaller scale;

FIG. 2C (previously described) is a cross-section of the prior art lifter bar assembly of FIGS. 1, 2A, and 2B mounted on the shell, drawn at a larger scale;

FIG. 3A is a top view of a portion of an embodiment of a grinding mill of the invention with an embodiment of a lifter bar assembly of the invention mounted on a shell thereof, drawn at a smaller scale;

FIG. 3B is a partial isometric view of a portion of the grinding mill of FIG. 3A, drawn at a smaller scale;

FIG. 3C is a partial isometric view of a portion of another embodiment of the grinding mill of the invention with another embodiment of the lifter bar assembly of the invention mounted on the shell;

FIG. 3D is a top view of a portion of the lifter bar assembly of FIG. 3A, drawn at a larger scale;

FIG. 3E is a top view of a portion of an alternative embodiment of the lifter bar assembly of the invention;

FIG. 3F is a top view of a portion of another embodiment of the grinding mill of the invention with another embodiment of the lifter bar assembly of the invention mounted on the shell, drawn at a smaller scale;

FIG. 4 is a top view of a portion of an alternative embodiment of the grinding mill of the invention with an alternative embodiment of the lifter bar assembly of the invention mounted on the shell;

FIG. 5A is a cross-section of an embodiment of a grinding mill of the invention, drawn at a smaller scale;

FIG. 5B is a longitudinal cross-section of the grinding mill of FIG. 5A;

FIG. 5C is a longitudinal cross-section of an embodiment of the grinding mill of the invention, drawn at a smaller scale;

FIG. 5D is a longitudinal cross-section of another embodiment of the grinding mill of the invention;

FIG. 6 is a top view of a portion of another embodiment of the grinding mill of the invention with another embodiment of the lifter bar assembly of the invention mounted on the shell, drawn at a larger scale;

FIG. 7 is a top view of a portion of the grinding mill of FIG. 3C with the lifter bar assembly of FIG. 3C mounted on the shell;

FIG. 8 is a top view of a portion of another embodiment of the grinding mill of the invention with another embodiment of the lifter bar assembly of the invention mounted on the shell; and

FIG. 9 is a top view of a portion of another embodiment of the grinding mill of the invention with another embodiment of the lifter bar assembly of the invention mounted on the shell.

### DETAILED DESCRIPTION

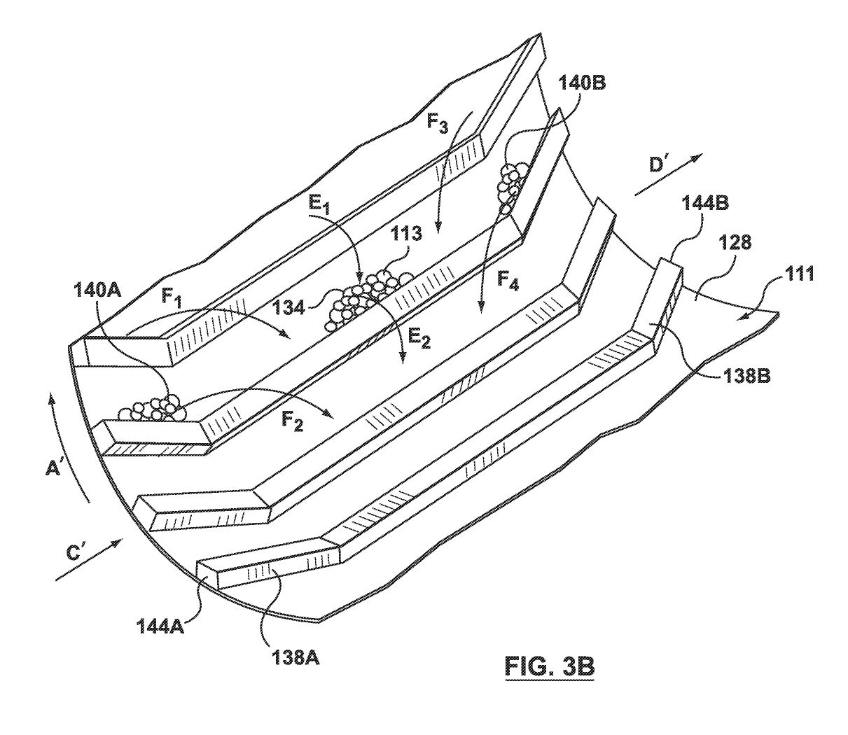

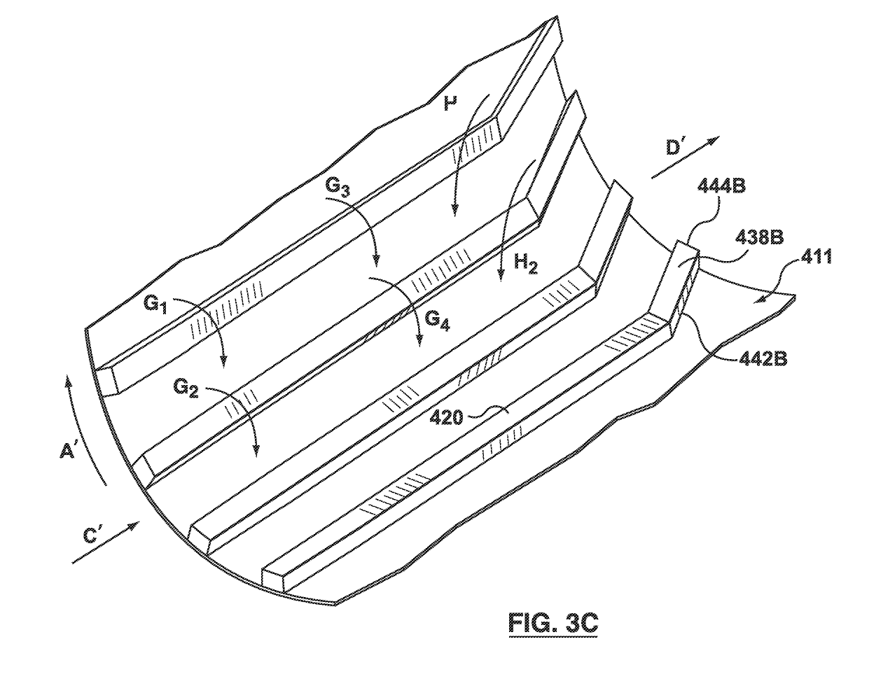

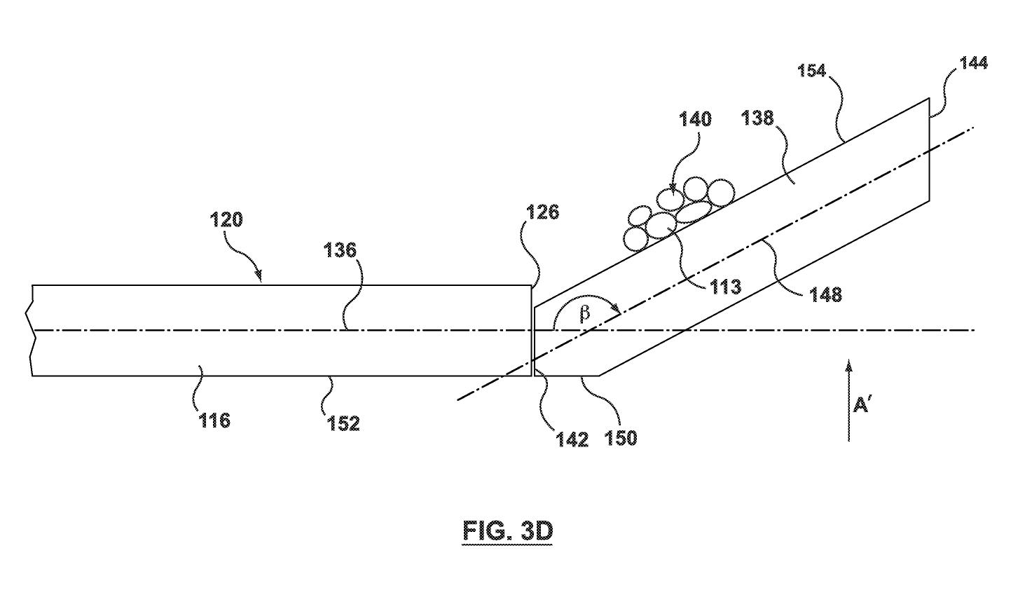

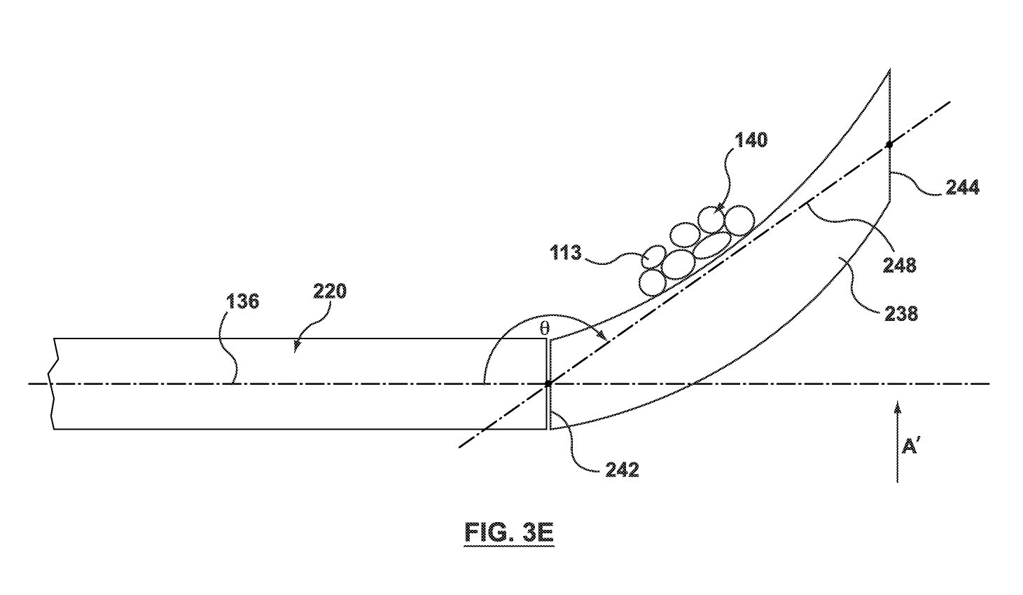

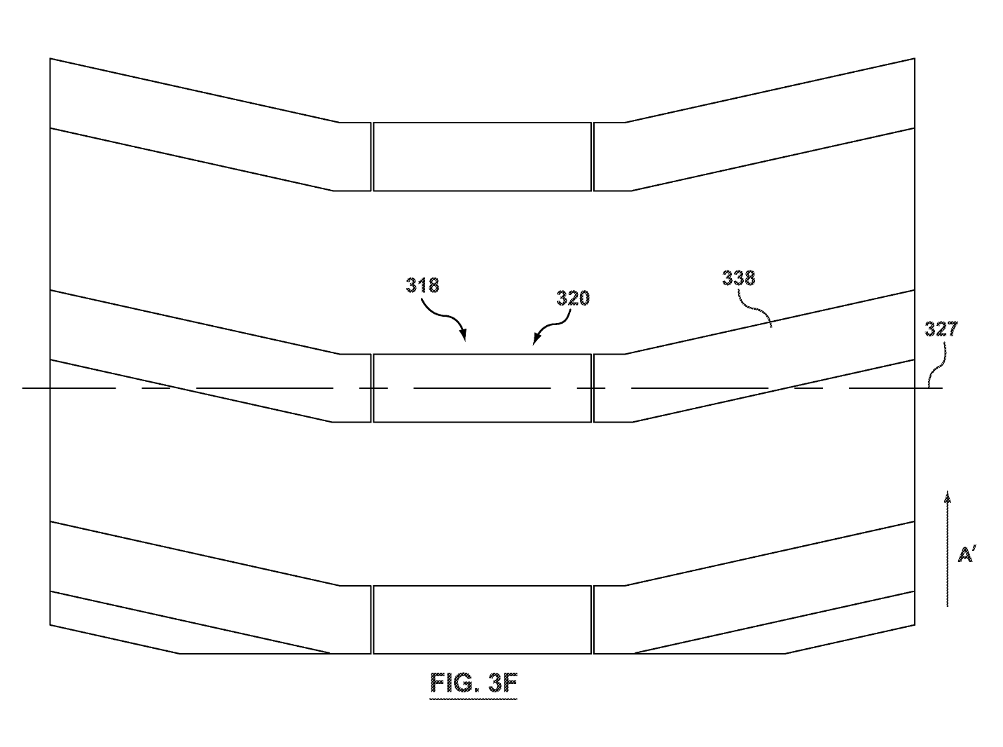

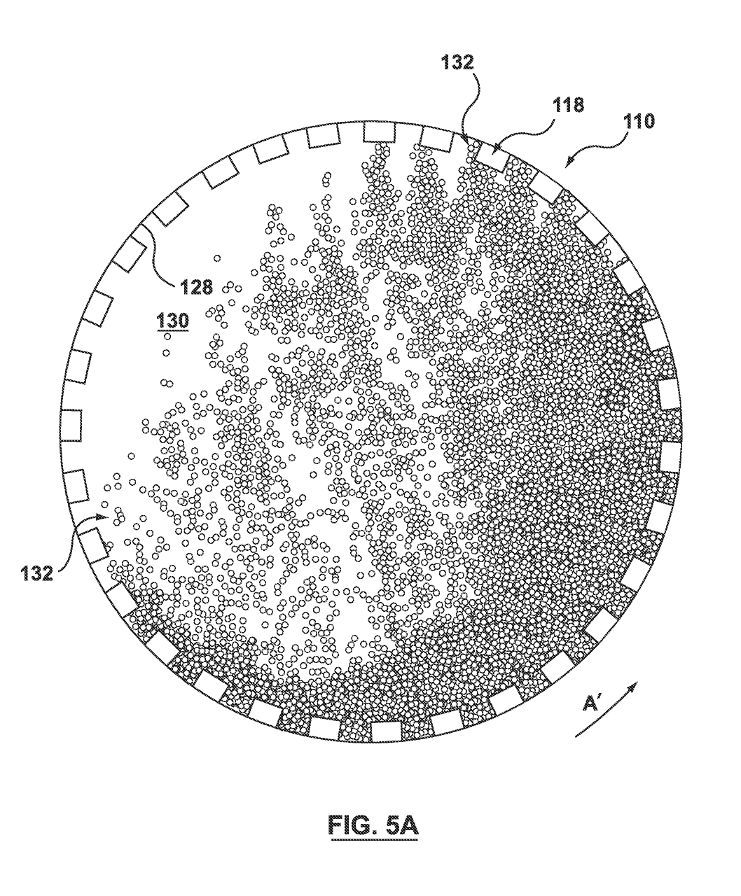

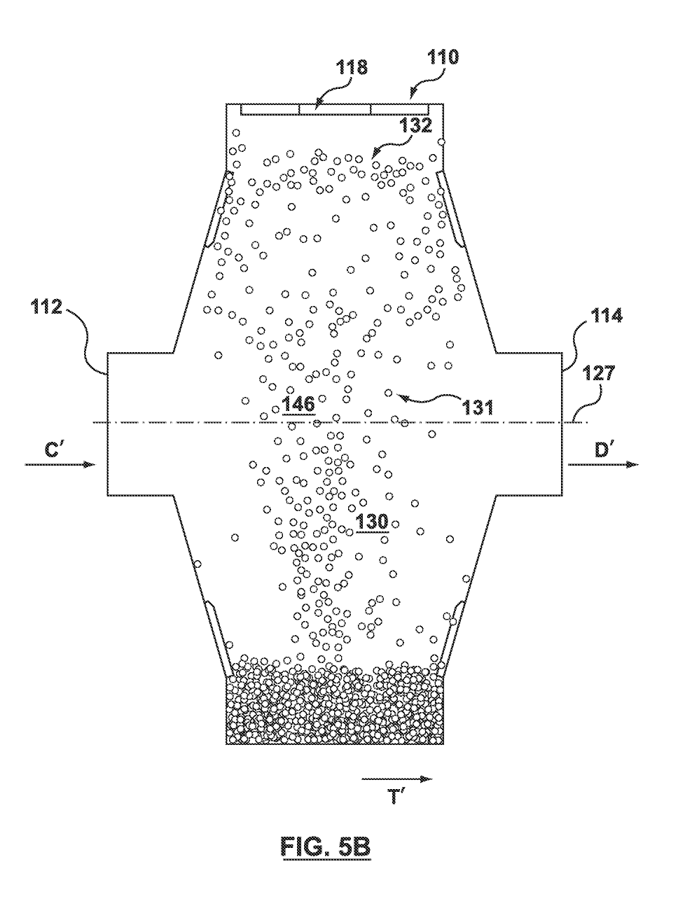

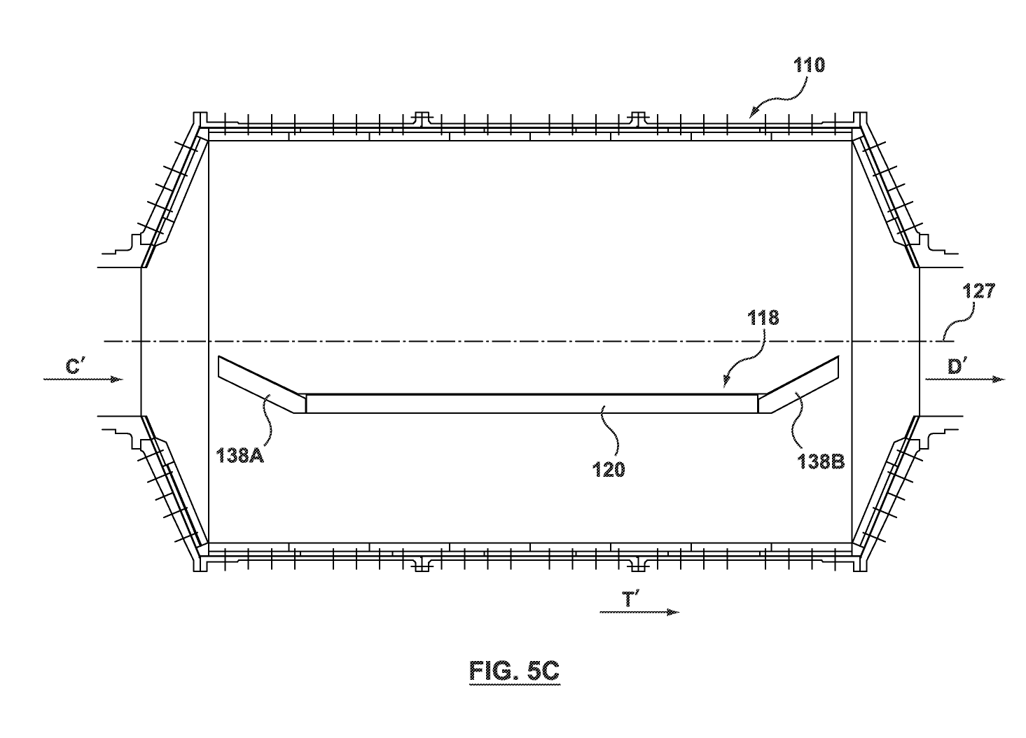

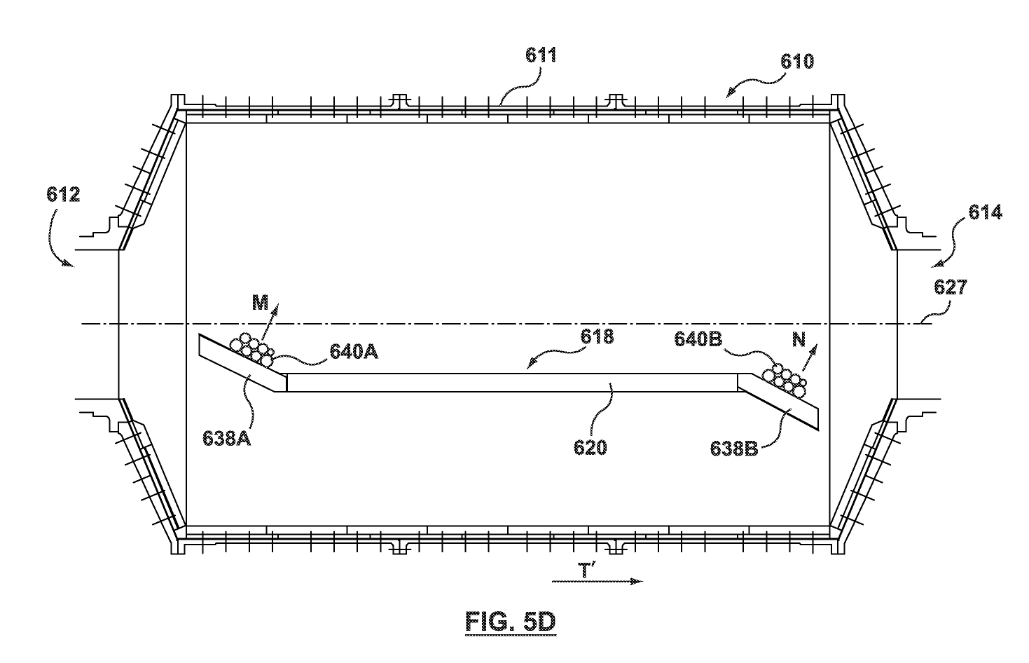

In the attached drawings, like reference numerals designate corresponding elements throughout. Reference is first made to FIGS. 3A, 3B, 3D-3F, and 5A-5C to describe an embodiment of a grinding mill of the invention referred to generally by the numeral 110. In one embodiment, the grinding mill 110 includes a shell 111 rotatable around a central axis 127 (FIGS. 5B, 5C) thereof, the shell 111 having an interior side 128 thereof at least partially defining a cavity 130 (FIGS. 5A-5C) therein. Preferably, the shell 111 extends between a feed end 112 thereof, at which ore 113 is introduced into the cavity 130 (as schematically indicated by arrow C′ in FIGS. 3B, 5B, and 5C), and a discharge end 114, at which ore 113 exits the cavity (as schematically indicated by arrow D′ in FIGS. 3B, 5B, and 5C), after comminution thereof (FIGS. 3B, 5B, 5C). The grinding mill 110 preferably also includes one or more lifter bar assemblies 118 mounted on the shell 111 for lifting at least a lifted portion 132 of a charge 131 (FIGS. 5A, 5B) including the ore in the cavity 130 as the shell 111 rotates, for comminution of the ore (FIG. 3B). As can be seen in FIG. 3B, each lifter bar assembly 118 preferably includes one or more main portions 120, for lifting and directing a main part 134 (FIG. 3B) of the lifted portion 132 of the charge 131. The main portion 120 includes one or more main portion lifter bars 116 at least partially defined by a center axis 136 thereof. Preferably, each main portion lifter bar 116 is mounted to the interior side 128 of the shell 111 to locate the center axis 136 thereof substantially parallel to the central axis 127 of the shell 111. The main portion 120 extends between respective ends 124, 126 thereof (FIG. 3A) and is positioned for directing the main part 134 (FIG. 3B) of the lifted portion 132 of the charge 131 in a main part direction (indicated by arrows E₁-E₂ in FIG. 3B) substantially orthogonal to the central axis 127 of the shell 111. It is also preferred that the grinding mill 110 includes one or more terminal lifter bars 138 (FIG. 3D) for lifting and directing one or more terminal parts 140 of the lifted portion 132 of the charge 131 (FIG. 3B). As can be seen in FIG. 3A, the terminal lifter bar 138 extends between inner and outer ends thereof 142, 144 and is mounted to the interior side 128 of the shell 111. Preferably, the outer end 144 of the terminal lifter bar 138 is positioned proximal to a selected end of the shell 111 selected from the group consisting of the feed and discharge ends 112, 114 thereof, as will be described. It is also preferred that the terminal lifter bar 138 is positioned for directing the terminal part 140 of the lifted portion 132 of the charge 131 at least partially in a terminal part direction (the terminal part directions being indicated, for example, by arrows F₁-F₄ in FIG. 3B) which are substantially non-aligned with the main part direction.

It will be understood that the feed and discharge ends 112, 114 are omitted from FIG. 3B for clarity of illustration. As illustrated in FIGS. 5A and 5B, when the shell 111 is rotating, the charge 131 generally occupies a substantial portion of the cavity 130. It will be understood that the charge is omitted from FIG. 3A for clarity of illustration. Also, in FIG. 3B, only small portions of the charge 131 are shown, for clarity of illustration.

It will also be understood that, although the manner in which a single lifter bar assembly directs the lifted portion of the charge is described herein, the grinding mill 110 preferably includes a number of lifter bar assemblies 118 mounted to the interior side of the shell around the circumference thereof, spaced apart by the spacing S′ (FIG. 3A).

As can be seen in FIGS. 3A and 3B, in one embodiment, terminal lifter bars 138A, 138B are positioned with the outer ends thereof 144A, 144B proximal to the feed and discharge ends 112, 114 of the shell 111. The feed end terminal lifter bars 138A and the discharge end terminal lifter bars 138B are positioned for directing the feed and discharge terminal parts 140A, 140B of the lifted portion 132 of the charge 131 respectively at least partially in feed and discharge terminal part directions (indicated in FIG. 3B by arrows F₁, F₂ and F₃, F₄ respectively) which are substantially non-aligned with the main part direction (indicated in FIG. 3B by arrows E₁, E₂).

In this embodiment, the terminal part 140A of the lifted portion 132 is directed generally away from the feed end 112, and the terminal part 140B is directed generally away from the discharge end 114 (FIG. 3B). It will be understood that the terminal part direction of the terminal part 140A that is directed by the terminal lifter bars 138A is generally indicated by arrows F₁ and F₂ in FIG. 3B. Also, the terminal part direction in which the terminal part 140B (i.e., directed by the terminal lifter bars 138B) is indicated by arrows F₃ and F₄ in FIG. 3B. It can therefore be seen that this embodiment is intended to minimize wear of the elements of the mill located at the feed and discharge ends 112, 114 respectively.

Preferably, the cavity 130 includes a central region 146 (FIG. 5B) located between the feed and discharge ends 112, 114 of the shell 111. In one embodiment, it is also preferred that each terminal lifter bar 138 directs the terminal part 140 of the lifted portion 132 of the charge 131 substantially toward the central region 146 of the cavity 130.

It would also be appreciated by those skilled in the art that control by the operator of the movement of the charge inside the rotating shell, to the extent feasible, is desirable. The invention described herein provides a means for controlling movement of the charge inside the shell in a predetermined manner, to an extent. For example, and as described above, the operator may wish to have the parts of the lifted portion of the charge proximal to the feed and discharge ends (e.g., the “feed and discharge terminal parts” 140A, 140B) directed away from the feed and discharge ends respectively, to reduce wear on the elements at the feed and discharge ends, i.e., as compared to the prior art. With different embodiments of the invention described herein, there are other ways in which movement of the charge is controllable to an extent, as will be described.

Those skilled in the art would appreciate that the performance of a grinding mill is affected by a large number of parameters. For example, the speed at which the shell rotates, the relevant characteristics of the ore, the rate at which the fresh feed of ore is input into the shell, the size of the shell, and the spacing between lifter bars can all have significant impacts on the grinding mill's overall performance. Generally, a balance is sought between competing objectives (e.g., minimizing wear and maximizing throughput, and optimizing energy consumption), in determining optimum values for the various parameters. It will also be appreciated by those skilled in the art that, because the various parameters involved often affect each other when varied, an iterative process of changing one parameter only (i.e., to assess the effect of such change) may be needed to determine parameters for optimum performance.

In one embodiment, and as shown in FIGS. 3A and 3B, each terminal lifter bar 138 preferably is positioned for directing the terminal part 140 of the lifted portion 132 of the charge 131 substantially away from the selected end(s) of the shell 111. As will be described, in certain embodiments of the invention, the terminal lifter bars are positioned for directing the terminal part of the charge away from the discharge end only, or away from the feed end only. However, in the embodiment of the invention illustrated in FIGS. 3A, 3B, and 5C, it is preferred that the grinding mill 110 includes terminal lifter bars positioned for directing terminal parts of the lifted portion of the charge away from both the discharge end 114 and the feed end 112, to minimize wear on the elements positioned at both ends of the shell, as described above.

In one embodiment, the inner and outer ends 142, 144 of the terminal lifter bar 138 substantially define a terminal lifter bar axis 148 therebetween (FIG. 3D). Preferably, the terminal lifter bar axis 148 is non-aligned with the central axis 127 of the shell 111. In one embodiment, and as shown, for instance, in FIGS. 3A, 3B, 3D, and 3F, the terminal lifter bar 138 is substantially straight.

As can be seen in FIG. 3D, in one embodiment, the substantially straight terminal lifter bar 138 preferably is not rectangular in plan view. Instead, the terminal lifter bar 138 preferably includes a flattened edge portion 150 which is substantially aligned with a trailing edge 152 of the main portion 120. Also, the terminal lifter bar 138 preferably includes an engagement surface 154 (FIGS. 3A, 3B, 3D) for engaging at least a proportion of the terminal part 140 (not shown in FIG. 3D). As can be seen in FIGS. 3A, 3B, and 3D, in one embodiment, the engagement surface 154 preferably is substantially straight.

An alternative embodiment of a terminal lifter bar 238 preferably is non-linear (FIG. 3E). The terminal lifter bar 238 is formed (i.e., in a non-linear shape) and positioned on the shell to direct the terminal part of the lifted portion of the charge at least partially in a terminal part direction, which is non-aligned with the main part direction. In this embodiment, the non-linear shape of the terminal lifter bar 238 preferably includes an engagement surface 254 which is non-linear. Preferably, and as can be seen in FIG. 3E, the non-linear engagement surface 254 is formed to define a substantially concave curve, to provide a slightly more defined engagement surface 254, for directing the terminal part away from the selected end of the shell. Depending on the circumstances, the non-linear lifter bar may more effectively direct the terminal part 140 in the terminal part direction. Those skilled in the art would appreciate that the non-linear terminal lifter bar 238 may have any non-linear shape that appears to be advantageous. In one embodiment, the non-linear terminal lifter bar 238 is at least partially defined by an axis 248 extending between midpoints of the inner and outer ends 242, 244 thereof. As can be seen in FIG. 3E, the center axis 136 of the main portion 220 and the axis 248 substantially define a preselected angle θ therebetween.

In another embodiment, the shell 111 is rotatable in a preselected rotation direction, e.g., in the direction indicated by arrow A′, in FIGS. 3A, 3B, 3D, 3E, and 3F. Preferably, and as can be seen in FIGS. 3A and 3D, the terminal lifter bar axis 148 and the center axis 136 of the main portion lifter bar define a preselected angle (designated α, β, in FIG. 3A) open toward the preselected rotation direction. In one embodiment, each of the preselected angles α, β is greater than 90° and less than 180°. It will be appreciated by those skilled in the art that the determination of the preselected angles α, β in each grinding mill is based on a number of parameters, as described above. Those skilled in the art will appreciate that α and β are not necessarily equal, although they may be. For instance, in one exemplary grinding mill, it has been found that, where each of the preselected angles α, β is approximately 167.5°, acceptable results were achieved.

As can be seen in FIG. 3E, in one embodiment, the preselected angle θ preferably is open in the preselected rotation direction (indicated by arrow A′ in FIG. 3E). Preferably, the preselected angle θ is greater than 90° and less than 180°.

It will be understood that, although the non-linear terminal lifter bar illustrated in FIG. 3E is positioned proximal to the discharge end, the non-linear terminal lifter bar, if appropriately configured or formed, is positionable at the feed end.

FIGS. 5A and 5B are based on graphic results of a computer simulation of the behaviour of the charge while the mill shell 111 is rotating. A computer model was generated of a shell having a diameter of 32 feet, and a length of 11 feet, 6 inches, and in which the shell rotates at 10 rpm. The simulation was generated using discrete element simulation analysis.

In the model, the main portion 120 of each lifter bar assembly 118 included only one lifter bar, being a substantially straight lifter bar about 2.6 feet (800 mm) long. In the model, each lifter bar assembly 118 included first and second terminal lifter bars, each being about 3.8 feet (1,180 mm) in length. Each terminal lifter bar in the model includes an engagement surface 154 about 3.25 feet (1,000 mm) long, and a flattened edge part 150 about seven inches (180 mm) long.

In the model, the straight parts of the terminal lifter bars were positioned at about 167.5°, i.e., α and β were each approximately 167.5°. Each lifter bar assembly 118 in the model is configured generally as shown in FIG. 3A. The results are shown in FIGS. 5A and 5B, which show the charge generally directed away from the feed and discharge ends when released from a lifter bar assembly, i.e., as the lifter bar assembly is moved up to about the 1:00 position. It appears that, on average, a particle is directed about 1.05 meters toward the central region by the terminal lifter bars 138A, 138B in this model.

Those skilled in the art would appreciate that the lengths of the main portion and the terminal lifter bars may also be varied, depending on the circumstances, to achieve optimum performance. In FIG. 3F, another embodiment of a lifter bar assembly 318 is shown. In this embodiment, the main portion 320 is relatively short, and the terminal lifter bars 338 are relatively long. As can be seen in FIG. 3F, the main portion 320 is substantially parallel to the central axis 327, and the terminal lifter bars 338 are non-aligned with the central axis 327. The predetermined rotation direction is indicated by the arrow A′ in FIG. 3F.

### INDUSTRIAL APPLICABILITY

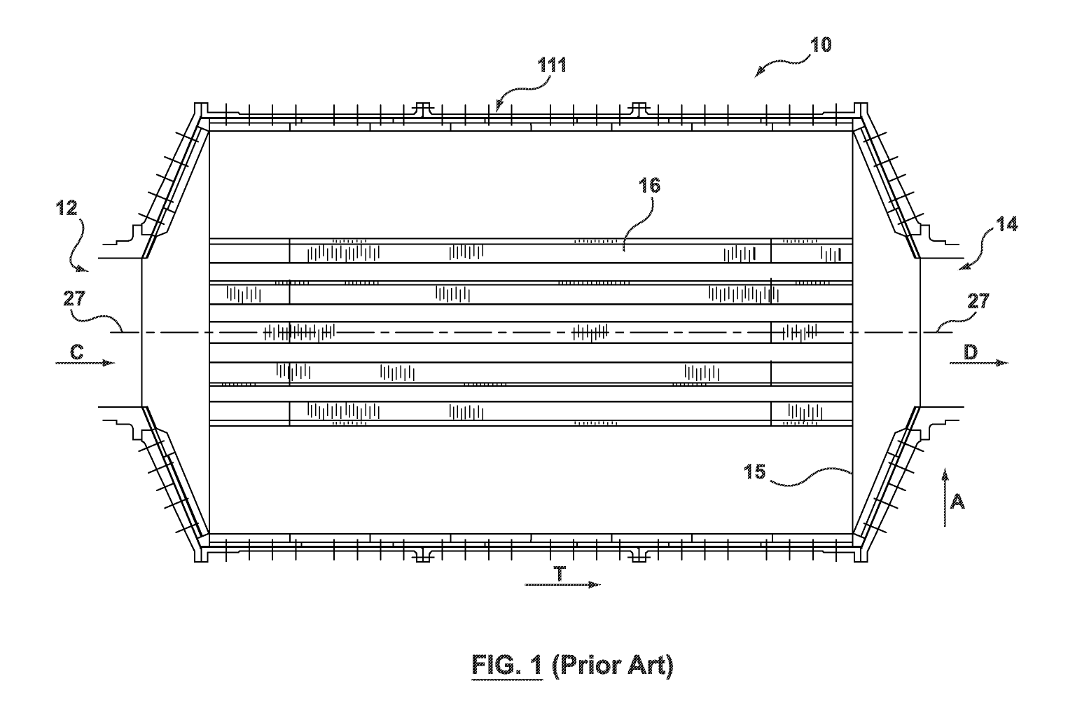

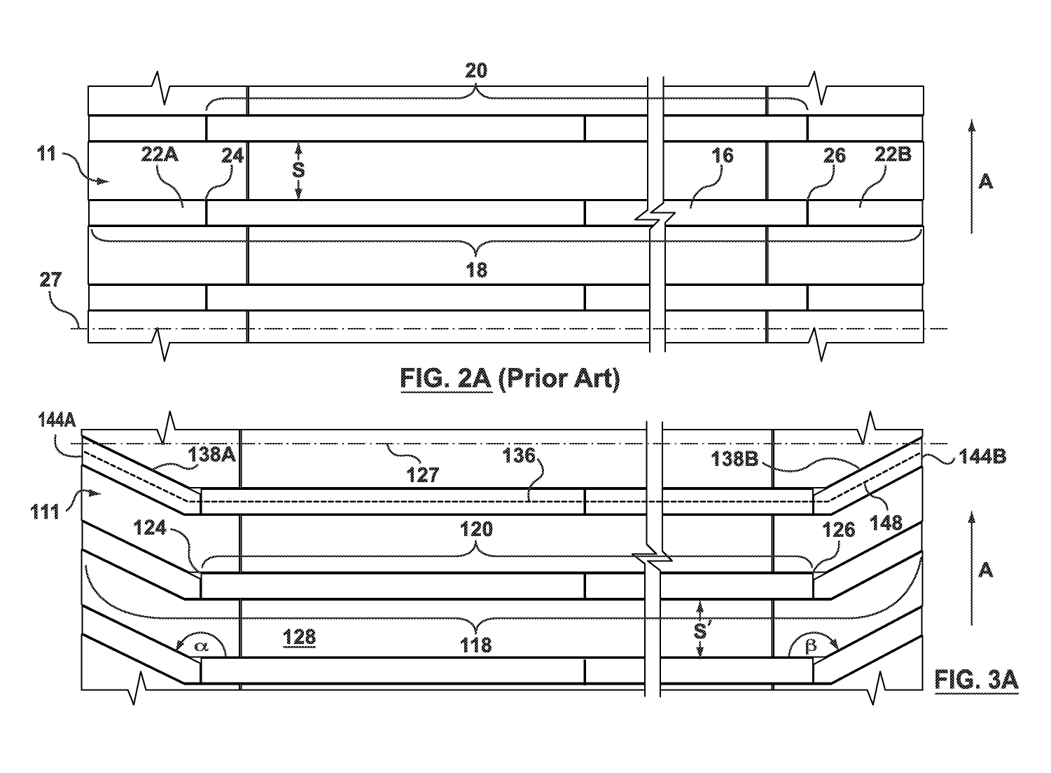

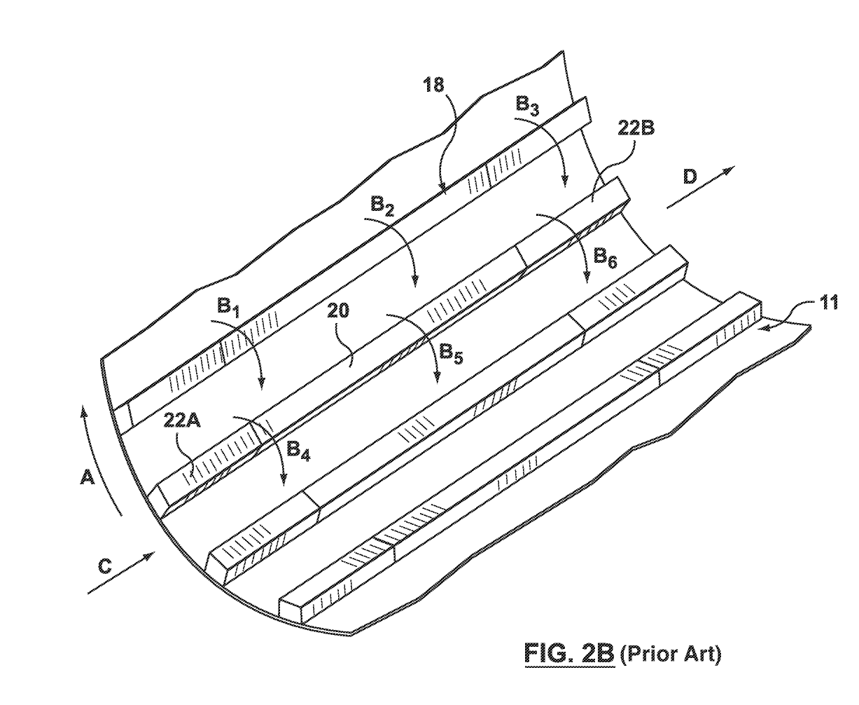

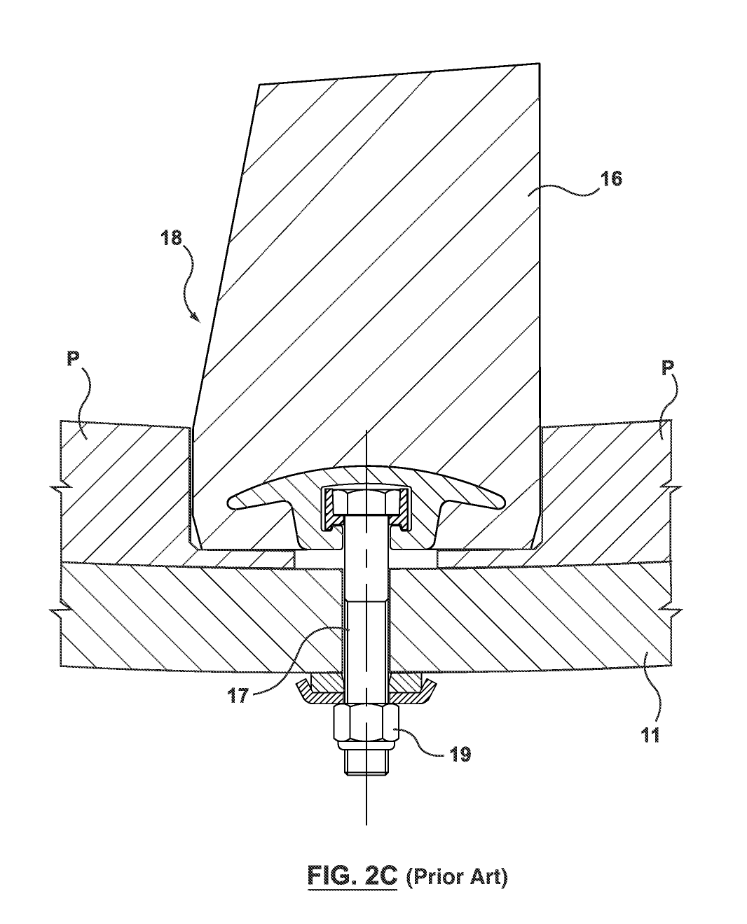

In use, because the terminal lifter bars 138A, 138B are positioned for respectively directing the terminal parts 140A, 140B at least partially in the terminal part directions (in FIG. 3B, indicated by arrows F₁, F₂ and F₃, F₄ respectively) that are substantially non-aligned with the main part direction (indicated by arrows E₁, E₂ in FIG. 3B), the movement of the lifted portion 132 of the charge 131 in the shell 111 is, to an extent, controllable by locating the terminal lifter bars 138A in selected positions. In FIGS. 3A, 3B, and 3F, the terminal lifter bars 138A, 138B located at the respective ends of the shell 111 are positioned for directing the terminal parts 140A, 140B substantially away from the feed and discharge ends 112, 114 of the shell 111 respectively. As noted above, in this embodiment, as compared to the prior art (illustrated in FIGS. 1, 2A, and 2B), wear on elements located at the feed and discharge ends 112, 114 of the shell 111 is decreased. This would result in cost savings, also as noted above.

Those skilled in the art would appreciate that the embodiment disclosed in FIGS. 3A, 3B, and 3F would tend to affect the rate of throughput, as compared to the prior art lifter bar arrangements, as follows. First, because the terminal part direction resulting from the positioning of the terminal lifter bar 138A is at least partly toward the discharge end 114 (i.e., at least partly in the general direction of movement of ore (indicated by arrow T′ in FIGS. 5B and 5C)), the net result of the positioning of the terminal lifter bar 138A would be tend to increase the rate of throughput. However, because the terminal lifter bar 138B is positioned for directing the terminal part 140B at least partially toward the feed end 112, the net result of the positioning of the terminal lifter bar 138B would be to tend to decrease the rate of throughput. If the angles α and β are equal, then these opposing effects (i.e., tending to increase and decrease the rate of throughput, respectively) may be thought to substantially cancel each other. However, it is thought that the positioning of the terminal lifter bar 138B may have a greater impact on the rate of throughput. This is because the terminal part 140B may, at least to an extent, impede the comminution of the ore in the main part 134. On the other hand, it is believed that, in some circumstances, the ground mill slurry flows readily through the charge mass into the discharge grates.

Accordingly, those skilled in the art will also appreciate that the angles α and β do not necessarily need to be equal. Also, those skilled in the art will also appreciate that the magnitudes of α and β are determined by the conditions in a particular mill, and the performance which is desired. In general, each such angle may be between slightly more than 90° and slightly less than 180°. More specifically, each such angle is between approximately 145° and 170°. It will be understood that, although the invention is well suited for improving an existing mill's performance (i.e., via retrofitting), the invention may also be built into a mill, i.e., when the mill is initially constructed.

In summary, the advantages of the embodiment of the lifter bar assembly of the invention illustrated in FIGS. 3A, 3B, 3D-3F, and 5A-5C are as follows. First, and as noted above, such embodiment of the lifter bar assembly of the invention reduces wear on elements at the feed and discharge ends, including the discharge grate plates. Second, the mill including such embodiment of the lifter bar assembly is more energy-efficient overall. In the prior art, a portion of the energy inputs for rotating the mill shell are ultimately used to cause wear (e.g., to grind oversize ore pieces against a discharge grate plate). With the lifter bar assembly of the invention, such wear is reduced, meaning that for the same energy input, a higher proportion thereof is ultimately utilized in comminution, i.e., grinding the ore. Energy spent abrading the feed and discharge end elements can be minimized.

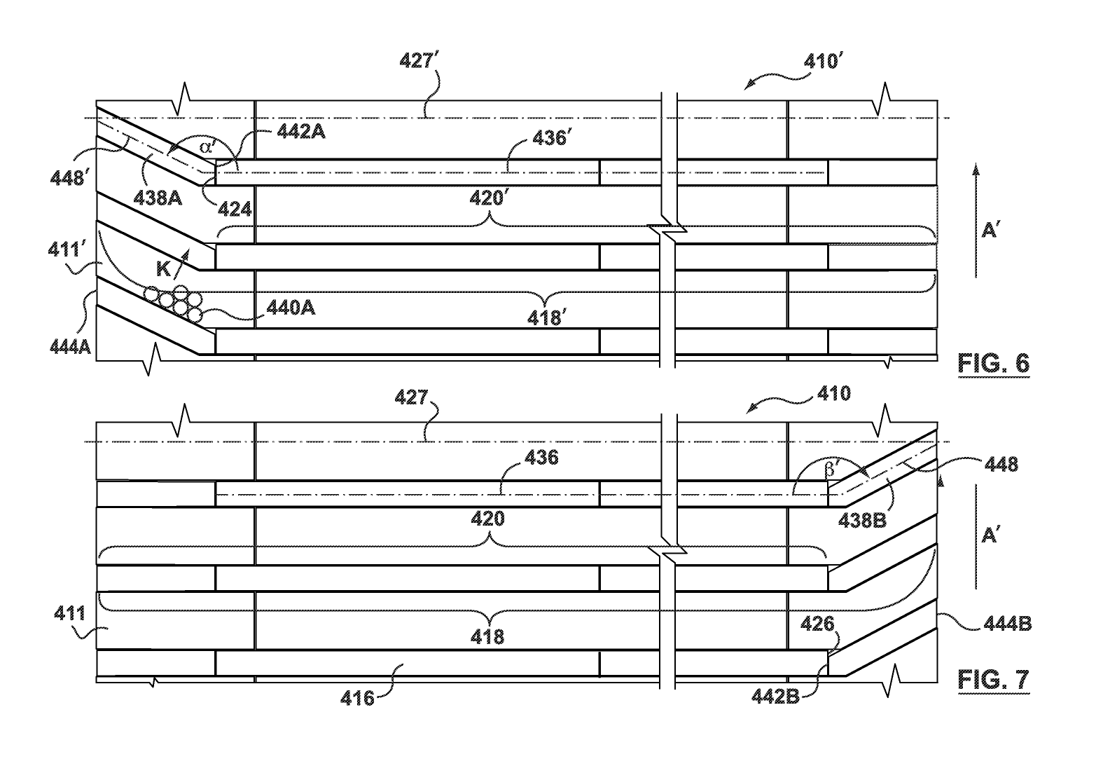

As noted above, in alternative embodiments, the terminal lifter bars are positioned proximal to only one of the feed end and the discharge end. Certain of these alternative embodiments are illustrated in FIGS. 3C, 6, and 7. In another embodiment of a grinding mill 410 of the invention, the inner end of a terminal lifter bar 438A, 438B is positioned proximal to a selected one of the ends of the main portion 420. For instance, an alternative embodiment of the lifter bar assembly 418 of the invention is illustrated in FIGS. 3C and 7. In one embodiment of the grinding mill 410, an outer end 444B of a terminal lifter bar 438B is located proximal to the discharge end of a shell 411. As can be seen in FIGS. 3C and 7, the lifter bar assembly 418 preferably includes only one terminal lifter bar 438B that is positioned in the vicinity of the discharge end (not shown in FIGS. 3C and 7) of the shell 411, i.e., in this case, the selected end of the shell is the discharge end. The preselected direction of rotation is indicated by arrow A′ in FIGS. 3C and 7.

As can be seen in FIG. 7, the lifter bar assembly 418 preferably includes a main portion 420 extending substantially between the feed end of the shell and an end 426 of the main portion 420. It is preferred that the terminal lifter bar 438B extends between inner and outer ends 442B, 444B thereof respectively, with the inner end 442B preferably positioned abutting, or at least adjacent to, the end 426 of the main portion 420. As shown in FIG. 7, the shell's central axis 427 and the main portion 420 are substantially parallel.

Depending on a number of factors (including, in particular, relevant characteristics of the ore), the performance of a mill may be improved by positioning only the terminal lifter bar 438B proximal to the discharge end at a preselected angle β′ diverging from a center axis 436 of the lifter bar(s) 416 in the main portion 420. For example, FIG. 7 discloses an alternative embodiment of the lifter bar assembly 418 of the invention in which the terminal lifter bar 438B preferably is positioned to define the preselected angle β′ between a terminal lifter bar axis 448 of the terminal lifter bar 438B and the center axis 436. As in other embodiments described above, the preselected angle β′ preferably is greater than 90° and less than 180°. The preselected angle β′ preferably is determined in each case based on such testing as is appropriate.

As can be seen in FIG. 3C, the ore is introduced via the feed end, as indicated by arrow C′. The main portion 420 lifts the main part of the lifted portion of the charge (not shown in FIG. 3C) and directs it in the main part direction, as indicated by arrows G₁-G₄. Based on FIGS. 3C and 7, it can be seen that the main part direction is substantially orthogonal to the central axis 427. The terminal lifter bars 438B lift the terminal part of the lifted portion of the charge (not shown in FIG. 3C) and directs the terminal part at least partially in the terminal part direction, as indicated by arrows H₁, H₂. Based on FIGS. 3C and 7, it can be seen that the terminal part direction is non-aligned with the main part direction.

Another alternative embodiment of the grinding mill 410′ of the invention is illustrated in FIG. 6. In one embodiment of the grinding mill 410′, an outer end 444A of a terminal lifter bar 438A is located proximal to the feed end of a shell 411′. As can be seen in FIG. 6, the lifter bar assembly 418′ preferably includes only one terminal lifter bar 438A that is positioned in the vicinity of the feed end (not shown in FIG. 6) of the shell 411′, i.e., in this case, the selected end of the shell is the feed end. The preselected direction of rotation is indicated by arrow A′ in FIG. 6.

As can be seen in FIG. 6, the lifter bar assembly 418′ preferably includes a main portion 420′ extending substantially between the discharge end of the shell and an end 424 of the main portion 420′. It is preferred that the terminal lifter bar 438A extends between inner and outer ends 442A, 444A thereof respectively, with the inner end 442A preferably positioned abutting, or at least adjacent to, the end 424 of the main portion 420′. As shown in FIG. 6, the shell's central axis 427′ and the main portion 420′ are substantially parallel.

Depending on a number of factors (including, in particular, relevant characteristics of the ore), the performance of a mill may be improved by positioning only the terminal lifter bar 438A proximal to the feed end at a preselected angle a′ diverging from a center axis 436′ of the lifter bar(s) 416′ in the main portion 420′. For example, FIG. 6 discloses an alternative embodiment of the lifter bar assembly 418′ of the invention in which the terminal lifter bar 438A preferably is positioned to define the preselected angle α′ between a terminal lifter bar axis 448′ of the terminal lifter bar 438A and the center axis 436′. As in other embodiments described above, the preselected angle α′ preferably is greater than 90° and less than 180°. The preselected angle α′ preferably is determined in each case based on such testing as is appropriate.

As indicated by arrow K in FIG. 6, a terminal part 440A of the lifted portion of the charge is directed by the lifter bar 438 generally in a terminal part direction that is away from the feed end as the shell rotates. It will be understood that most of the charge is omitted from FIG. 6 for clarity of illustration.

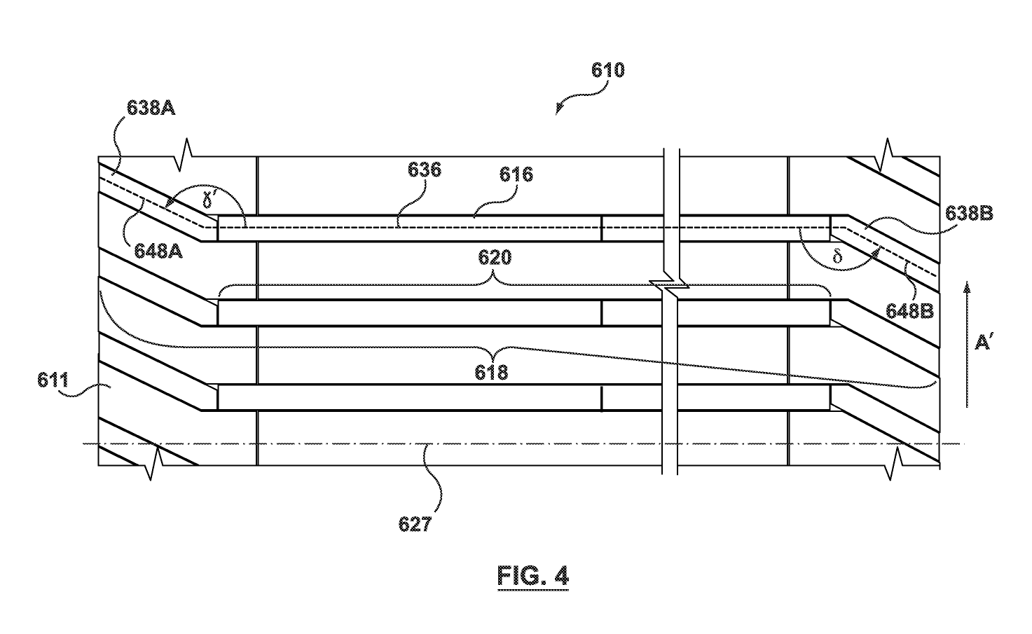

As noted above, it is possible that various arrangements of the lifter bars, in alternative embodiments of the lifter bar assembly of the invention, may be optimal in different circumstances. For instance, additional alternative embodiments of the grinding mill of the invention are illustrated in FIGS. 4, 5D, 8, and 9.

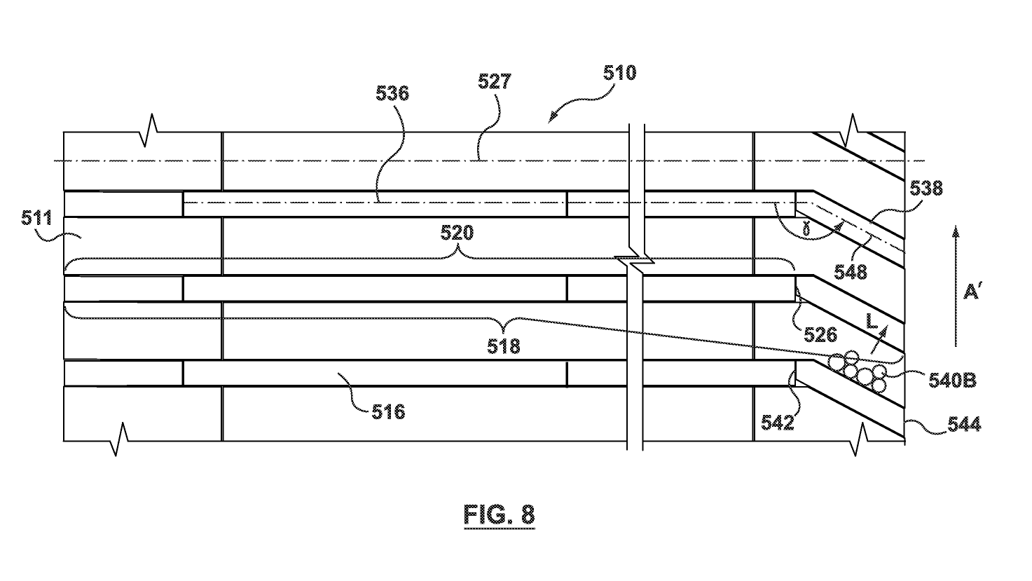

In FIG. 8, an embodiment of a grinding mill 510 is shown in which a terminal lifter bar 538 in a lifter bar assembly 518 is positioned for directing a terminal part of the lifted portion of the charge (not shown in FIG. 8) substantially toward a selected end of a shell 511. In FIG. 8, the selected end is the discharge end (not shown in FIG. 8). The preselected direction of rotation is indicated by arrow A′ in FIG. 8.

As can be seen in FIG. 8, the lifter bar assembly 518 preferably includes a main portion 520 extending substantially between the feed end of the shell and an end 526 of the main portion 520. It is preferred that the terminal lifter bar 538 extends between inner and outer ends 542, 544 thereof respectively, with the inner end 542 preferably positioned abutting, or at least adjacent to, the end 526 of the main portion 520. As shown in FIG. 8, the shell's central axis 527 and the main portion 520 are substantially parallel.

Depending on a number of factors (including, in particular, relevant characteristics of the ore), the performance of a mill may be improved by positioning only the terminal lifter bar 538 proximal to the discharge end at a preselected angle γ diverging from a center axis 536 of the lifter bar(s) 516 in the main portion 520. For example, FIG. 8 discloses an alternative embodiment of the lifter bar assembly 518 of the invention in which the terminal lifter bar 538 preferably is positioned to define the preselected angle γ between a terminal lifter bar axis 548 of the terminal lifter bar 538 and the center axis 536. As in other embodiments described above, the preselected angle γ preferably is greater than 90° and less than 180°. The preselected angle γ preferably is determined in each case based on such testing as is appropriate. As can be seen in FIG. 8, the preselected angle γ is open in a direction opposite to the direction of rotation.

The direction of rotation is understood to be in the counter-clockwise direction, i.e., if the shell 511 is viewed from the discharge end. It will be appreciated by those skilled in the art that the embodiment disclosed in FIG. 8 results in the terminal part 540B of the lifted portion of the charge being directed toward the discharge end, as indicated by arrow L. (It will be understood that most of the charge is omitted from FIG. 8 for clarity of illustration.) Although this would result in the elements at the discharge end being subjected to increased wear (as compared to the prior art), depending on the circumstances, the embodiment shown in FIG. 8 may provide optimum performance. For example, it appears likely that the lifter bar assembly 518 would also tend to cause a greater rate of throughput of the ore. In some circumstances, increased wear on the elements at the discharge end may be justifiable in view of the increase in throughput.

In FIGS. 4 and 5D, another alternative embodiment of a grinding mill 610 of the invention is illustrated. A lifter bar assembly 618 in the grinding mill 610 includes a main portion 620 and terminal lifter bars 638A and 638B positioned proximal to feed and discharge ends 612, 614 respectively. The grinding mill 610 includes a shell 611 on which the lifter bar assembly 618 is mounted. The main portion 620 and a central axis 627 of the shell 611 are substantially parallel. As can be seen in FIGS. 4 and 5D, the terminal lifter bar 638A is positioned to direct the terminal part of the lifted portion of the charge which is proximal to the feed end 612 away from the feed end 612. The terminal lifter bar 638B is positioned to direct the terminal part of the lifted portion of the charge which is proximal to the discharge end 614 toward the discharge end 614. Each of the terminal lifter bars 638A, 638B is non-aligned with the central axis 627 of the shell 611. Movement of the ore from the feed end 612 to the discharge end 614 is indicated by arrow T′ in FIG. 5D.

The preselected direction of rotation is indicated by arrow A′ in FIGS. 4 and 5D. The terminal lifter bar 638A preferably is positioned proximal to the feed end at a preselected angle δ diverging from a center axis 636 of the lifter bar(s) 616 in the main portion 620. As can be seen in FIG. 4, the terminal lifter bar 638A preferably is positioned to define the preselected angle δ between a terminal lifter bar axis 648A of the terminal lifter bar 638A and the center axis 636. As in other embodiments described above, the preselected angle δ preferably is greater than 90° and less than 180°. The preselected angle δ preferably is determined based on such testing as is appropriate.

The terminal lifter bar 638B preferably is positioned proximal to the discharge end at a preselected angle γ′ diverging from the center axis 636 of the lifter bar(s) 616 in the main portion 620. As can be seen in FIG. 4, the terminal lifter bar 638B preferably is positioned to define the preselected angle γ′ between a terminal lifter bar axis 648B of the terminal lifter bar 638B and the center axis 636. As in other embodiments described above, the preselected angle γ′ preferably is greater than 90° and less than 180°. The preselected angle γ′ preferably is determined based on such testing as is appropriate.

As can be seen in FIG. 5D, a terminal part 640A is directed by the terminal lifter bar 638A in a terminal part direction (indicated by arrow M in FIG. 5D) that is generally away from the feed end 612. Another terminal part 640B is directed in a terminal part direction (indicated by arrow N in FIG. 5D) that is generally toward the discharge end 614. It will be understood that most of the charge is omitted from FIG. 5D (and that the charge is omitted from FIG. 4) for clarity of illustration.

Those skilled in the art would appreciate that it would appear that the lifter bar assembly 618 would have the effect of increasing throughput, as compared to the prior art. However, with increased throughput, certain elements inside the shell would be subjected to increased wear. As described above, depending on the circumstances, the lifter bar assembly 618 may in some situations represent an optimal design.

As described above, a variety of parameters may affect the performance of a grinding mill. Different arrangements of terminal lifter bars relative to the main portion of the lifter bar assembly, and different combinations of arrangements (e.g., terminal lifter bars at the feed end, and terminal lifter bars at the discharge end) may be suitable.

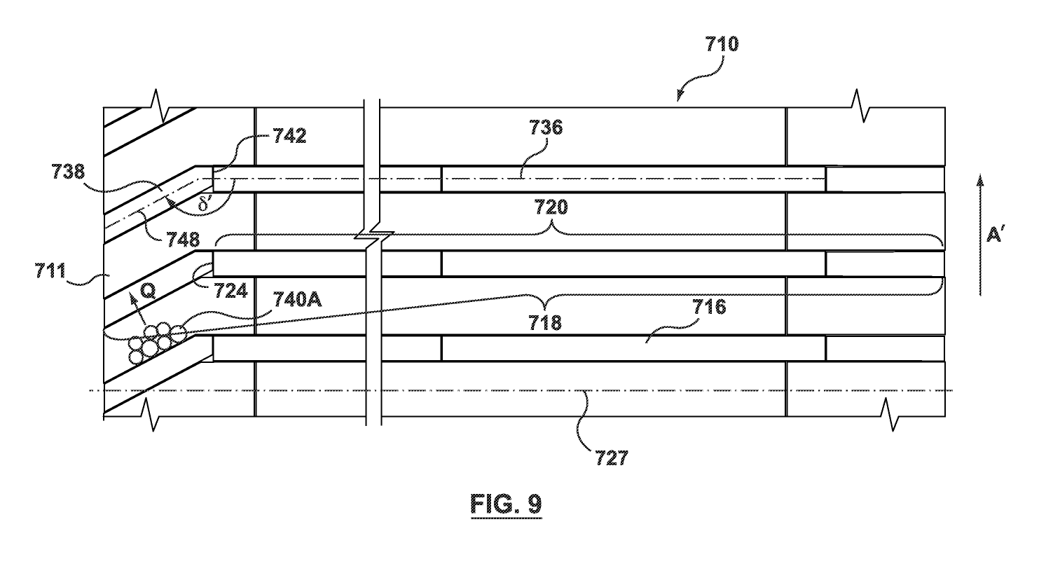

In FIG. 9 an embodiment of a grinding mill 710 is shown in which a terminal lifter bar 738 in a lifter bar assembly 718 is positioned for directing a terminal part of the lifted portion of the charge (not shown in FIG. 9) substantially toward the feed end of a shell 711. The preselected direction of rotation is indicated by arrow A′ in FIG. 9.

As can be seen in FIG. 9, the lifter bar assembly 718 preferably includes a main portion 720 extending substantially between the discharge end of the shell and an end 724 of the main portion 720. It is preferred that the terminal lifter bar 738 extends between inner and outer ends 742, 744 thereof respectively, with the inner end 742 preferably positioned abutting, or at least adjacent to, the end 724 of the main portion 720. As shown in FIG. 9, the shell's central axis 727 and the main portion 720 are substantially parallel.

Depending on a number of factors (including, in particular, relevant characteristics of the ore), the performance of a mill may be improved by positioning only the terminal lifter bar 738 proximal to the feed end at a preselected angle δ′ diverging from a center axis 736 of the lifter bar(s) 716 in the main portion 720. For example, FIG. 9 discloses an alternative embodiment of the lifter bar assembly 718 of the invention in which the terminal lifter bar 738 preferably is positioned to define the preselected angle δ′ between a terminal lifter bar axis 748 of the terminal lifter bar 738 and the center axis 736. As in other embodiments described above, the preselected angle δ′ preferably is greater than 90° and less than 180°. The preselected angle δ′ preferably is determined in each case based on such testing as is appropriate.

As indicated by arrow Q in FIG. 9, a terminal part 740A is directed by the terminal lifter bar 738 in a terminal part direction that is generally toward the feed end. It will be understood that most of the charge is omitted from FIG. 9 for clarity of illustration.

The direction of rotation is understood to be in the counter-clockwise direction, i.e., if the shell 711 is viewed from the discharge end. It will be appreciated by those skilled in the art that the embodiment disclosed in FIG. 9 results in the terminal part of the lifted portion of the charge (not shown in FIG. 9) being directed toward the feed end. Although this would result in the elements at the feed end being subjected to increased wear (as compared to the prior art) and tend to decrease the rate of throughput, those skilled in the art would appreciate that there may be circumstances in which the lifter bar assembly 718 (whether used with other lifter bar assemblies or not) may be advantageous.

From the foregoing, it can be seen that the invention provides means for controlling movement of the charge inside the shell in a predetermined manner. For instance, the terminal parts of the lifted portion of the charge are directable toward or away from the feed and/or discharge ends respectively, as required. As noted above, it will be understood that the lifter bar assemblies of the invention are mounted around the circumference of the interior side of the shell. In connection with each embodiment described above, the description is focused on a single lifter bar assembly, for clarity. Each lifter bar assembly preferably includes fasteners (not shown in FIGS. 3A-9) for fastening the lifter bars to the shell, as is known in the art. Those skilled in the art would appreciate that, in the same shell, elements of one embodiment of the invention disclosed herein may be mounted along with elements of other embodiments.

Preferably, an embodiment of a lifter bar assembly 118 of the invention is for lifting the portion 132 of the charge 131 including the ore 113 in the shell 111 of the grinding mill 110 as the shell rotates, for comminution of the ore. It is preferred that the lifter bar assembly 118 includes the main portion 120 for lifting and directing the main part 134 of the lifted portion 132 of the charge 131 (FIGS. 3A, 3B). The main portion includes the main portion lifter bar(s) 116 at least partially defined by the center axis thereof 136. Each main portion lifter bar 116 is mountable on the interior side 128 of the shell 111, to locate the center axis 136 thereof substantially parallel to the central axis 127 of the shell 111. The main portion 120 is positionable for directing the main part 134 in the main part direction (indicated by arrows E₁, E₂ in FIG. 3B) which is substantially orthogonal to the central axis 127 of the shell 111. The lifter bar assembly 118 preferably also includes one or more terminal lifter bars 138 for lifting and directing the terminal parts 140 (FIG. 3D) of the lifted portion 132 of the charge 131. Each terminal lifter bar 138 extends between inner and outer ends thereof 142, 144. Also, each terminal lifter bar 138 is mountable to the interior side 128 of the shell, to locate the outer end 144 thereof proximal to a selected end of the shell selected from the group consisting of the feed and discharge ends thereof 112, 114. Each terminal lifter bar 138 is positionable on the interior side 128 for directing the terminal part 140 of the lifted portion 132 of the charge 131 at least partially in the terminal part direction (two terminal part directions being respectively indicated, for example, by arrows F₁, F₂ and F₃, F₄ in FIG. 3B) which is substantially non-aligned with the main part direction. As described above, the terminal parts are proximal to the feed and/or discharge ends, and preferably are directable toward or away from the feed and/or discharge ends respectively, as required.

It will be appreciated by those skilled in the art that the invention can take many forms, and that such forms are within the scope of the invention as described above. The foregoing descriptions are exemplary and their scope should not be limited to the preferred versions contained herein.

We claim:

1. A grinding mill comprising:
a shell rotatable around a central axis thereof, an interior side of the shell at least partially defining a cavity therein;
the shell extending between a feed end thereof, at which ore is introduced into the cavity, and a discharge end, at which the ore exits the cavity, after comminution thereof;
at least one lifter bar assembly mounted on the shell for lifting at least a lifted portion of a charge comprising the ore in the cavity as the shell rotates for comminution of the ore, said at least one lifter bar assembly comprising:
at least one main portion for lifting and directing a main part of the lifted portion of the charge, said at least one main portion comprising at least one main portion lifter bar at least partially defined by a center axis thereof;
said at least one main portion lifter bar being mounted to the interior side of the shell to locate the center axis thereof substantially parallel to the central axis of the shell;
said at least one main portion extending between two respective ends thereof and being positioned for directing the main part of the lifted portion of the charge in a main part direction substantially orthogonal to the central axis of the shell;
at least one terminal lifter bar for lifting and directing at least one terminal part of the lifted portion of the charge, said at least one terminal lifter bar extending between inner and outer ends thereof and being mounted to the interior side of the shell, the outer end of said at least one terminal lifter bar being positioned proximal to a selected end of the shell selected from the group consisting of the feed and discharge ends thereof; and
said at least one terminal lifter bar being positioned for directing said at least one terminal part of the lifted portion of the charge at least partially in a terminal part direction which is substantially non-aligned with the main part direction.

2. A grinding mill according to claim 1 in which said at least one terminal lifter bar is positioned for directing said at least one terminal part of the lifted portion of the charge substantially away from the selected end of the shell.

3. A grinding mill according to claim 1 in which said at least one terminal lifter bar is positioned for directing said at least one terminal part of the lifted portion of the charge substantially toward the selected end of the shell.

4. A grinding mill according to claim 1 in which:
the cavity comprises a central region located between the feed and discharge ends of the shell; and
said at least one terminal lifter bar directs said at least one terminal part of the lifted portion of the charge substantially toward the central region of the cavity.

5. A grinding mill according to claim 1 in which:
the inner and outer ends of said at least one terminal lifter bar substantially define a terminal lifter bar axis therebetween; and
the terminal lifter bar axis is non-aligned with the central axis of the shell.

6. A grinding mill according to claim 1 in which said at least one terminal lifter bar is substantially straight.

7. A grinding mill according to claim 1 in which said at least one terminal lifter bar is non-linear.

8. A grinding mill according to claim 5 in which:
the shell is rotatable in a preselected rotation direction; and
the terminal lifter bar axis and the center axis of said at least one main portion lifter bar define a preselected angle open toward the preselected rotation direction.

9. A grinding mill according to claim 8 in which the preselected angle is greater than 90° and less than 180°.

10. A grinding mill according to claim 9 in which the preselected angle is approximately 167.5°.

11. A grinding mill according to claim 1 in which the inner end of said at least one terminal lifter bar is positioned proximal to a selected one of the ends of said at least one main portion.

12. A grinding mill according to claim 1 in which the outer end of said at least one terminal lifter bar is located proximal to the feed end of the shell.

13. A grinding mill according to claim 1 in which the outer end of said at least one terminal lifter bar is located proximal to the discharge end of the shell.

14. A grinding mill comprising:
a shell rotatable around a central axis thereof, the shell comprising an interior side thereof at least partially defining a cavity therein;
the shell extending between a feed end thereof, at which ore is introduced into the cavity, and a discharge end, at which the ore exits the cavity, after comminution thereof;
at least one lifter bar assembly mounted on the shell for lifting at least a lifted portion of a charge comprising the ore in the cavity as the shell rotates for comminution of the ore, said at least one lifter bar assembly comprising:
at least one main portion for lifting and directing a main part of the lifted portion of the charge, said at least one main portion comprising at least one main portion lifter bar at least partially defined by a center axis thereof;
said at least one main portion lifter bar being mounted to the interior side of the shell to locate the center axis thereof substantially parallel to the central axis of the shell;
said at least one main portion extending between two respective ends thereof and being positioned for directing the main part of the lifted portion of the charge in a main part direction substantially orthogonal to the central axis of the shell;
a pair of terminal lifter bars for lifting and directing a terminal part of the lifted portion of the charge, the terminal lifter bars comprising a feed end terminal lifter bar and a discharge end terminal lifter bar, each said terminal lifter bar extending between inner and outer ends thereof and mounted to the interior side of the shell;
the outer end of the feed end terminal lifter bar being located proximal to the feed end of the shell, and the outer end of the discharge end terminal lifter bar being located proximal to the discharge end of the shell;
said at least one main portion extending between feed and discharge ends thereof, the feed end of said at least one main portion being positioned at a predetermined distance from the feed end of the shell, and the discharge end of said at least one main portion being positioned at a predetermined distance from the discharge end of the shell; and
the feed end and discharge end terminal lifter bars being positioned for directing the feed and discharge terminal parts of the lifted portion of the charge respectively at least partially in feed and discharge terminal part directions which are substantially non-aligned with the main part direction.

15. A grinding mill according to claim 14 in which the feed end and discharge end terminal lifter bars are positioned for directing the feed and discharge terminal parts of the lifted portion of the charge substantially away from the feed and discharge ends of the shell respectively.

16. A grinding mill according to claim 14 in which terminal lifter bars are positioned for directing at least a selected one of the feed and discharge terminal parts of the lifted portion of the charge substantially toward a predetermined one of the feed and discharge the ends of the shell.

17. A grinding mill according to claim 14 in which:
the cavity comprises a central region located between the feed and discharge ends of the shell; and
the feed end and discharge end terminal lifter bars direct the feed and discharge terminal parts of the lifted portion of the charge respectively toward the central region of the cavity.

18. A grinding mill according to claim 14 in which:
the inner and outer ends of each of the feed end and discharge end terminal lifter bars substantially define respective terminal lifter bar axes therebetween; and
the respective terminal lifter bar axes of the feed end and discharge end terminal lifter bars are non-aligned with the central axis of the shell.

19. A grinding mill according to claim 14 in which the feed end and discharge end terminal lifter bars are substantially straight.

20. A grinding mill according to claim 14 in which the feed end and discharge end terminal lifter bars are non-linear.

21. A grinding mill according to claim 18 in which:
the shell is rotatable in a preselected rotation direction; and
the terminal lifter bar axis of the feed end terminal lifter bar and the center axis of said at least one main portion lifter bar define a feed end angle open toward the preselected rotation direction; and
the terminal lifter bar axis of the discharge end terminal lifter bar and the center axis of said at least one main portion lifter bar define a discharge end angle open toward the preselected rotation direction.

22. A grinding mill according to claim 21 in which the feed end and discharge end angles are each greater than 90° and less than 180°.

23. A grinding mill according to claim 22 in which each of the feed end and discharge end angles is approximately 167.5°.

24. A grinding mill according to claim 14 in which the inner ends of the feed end and discharge end terminal lifter bars are positioned proximal to the feed and discharge ends of said at least one main portion respectively.

25. A lifter bar assembly for lifting a portion of a charge comprising ore in a shell of a grinding mill for comminution of the ore, the shell being rotatable around a central axis thereof and extending between feed and discharge ends thereof, the shell comprising an interior side thereof at least partially defining a cavity therein, the lifter bar assembly comprising:
at least one main portion for lifting and directing a main part of the lifted portion of the charge, said at least one main portion comprising at least one main portion lifter bar at least partially defined by a center axis thereof;
said at least one main portion lifter bar being mountable on the interior side of the shell to locate the center axis thereof substantially parallel to the central axis of the shell;
said at least one main portion being positionable for directing the main part in a main part direction substantially orthogonal to the central axis of the shell;
at least one terminal lifter bar for lifting and directing at least one terminal part of the lifted portion of the charge, said at least one terminal lifter bar extending between inner and outer ends thereof and being mountable to the interior side of the shell, to locate the outer end thereof proximal to a selected end of the shell selected from the group consisting of the feed and discharge ends thereof; and
said at least one terminal lifter bar being positionable on the interior side for directing said at least one terminal part of the lifted portion of the charge at least partially in a terminal part direction which is substantially non-aligned with the main part direction.

26. A lifter bar assembly according to claim 25 in which said at least one terminal lifter bar is positionable for directing said at least one terminal part of the lifted portion of the charge substantially away from the selected end of the shell.

27. A lifter bar assembly according to claim 25 in which said at least one terminal lifter bar is positionable for directing said at least one terminal part of the lifted portion of the charge substantially toward the selected end of the shell.

28. A lifter bar assembly according to claim 25 in which:
the inner and outer ends of said at least one terminal lifter bar substantially define a terminal lifter bar axis therebetween; and
said at least one terminal lifter bar is positionable to locate the terminal lifter bar axis in a predetermined non-aligned location relative to the central axis of the shell.

29. A lifter bar assembly according to claim 25 in which said at least one terminal lifter bar is substantially straight.

30. A lifter bar assembly according to claim 25 in which said at least one terminal lifter bar is non-linear.
